(19) United States
(12) Patent Application Publication
(10) Pub. No.: US 2013/0154153 A1
(43) Pub. Date: Jun. 20, 2013

(54) MULTI-SHOT MOLDING METHOD WITH PRESSURE ACTIVATED EXPANSION LOCKS

(71) Applicant: Shape Corp., Grand Haven, MI (US)

(72) Inventors: Toby Jacobson, West Olive, MI (US); Brian Scheidmantel, Rockford, MI (US)

(73) Assignee: SHAPE CORP., Grand Haven, MI (US)

(21) Appl. No.: 13/719,738

(22) Filed: Dec. 19, 2012

Related U.S. Application Data
(60) Provisional application No. 61/577,726, filed on Dec. 20, 2011.

(51) Int. Cl. B29C 45/00

(52) U.S. Cl. CPC B29C 45/0003
USPC 264/255

(57) ABSTRACT

A co-molding process includes molding a body between a “common cavity” and “first shot core” die halves, co-molding a soft plastic onto the first component to form a final part using the “common cavity” die half and a “second shot core” die half. The “second shot core” die half includes shallow formations forming expansion locks along an elongated edge of the final part on a non-show concave surface, the locks having a shallow depth and extending in a direction non-parallel a die pull direction such that the locks affirmatively prevent shifting of first component during the co-molding process. Also, the locks can be made to cause the final part to remain with the “second shot core” die half when dies are opened during a final step of the co-molding process.

### CROSS-REFERENCE TO RELATED APPLICATION

This application claims benefit under 35 USC §119(e) of provisional application Ser. No. 61/577,726, filed Dec. 20, 2011, entitled MULTI-SHOT MOLDING METHOD WITH PRESSURE ACTIVATED EXPANSION LOCKS the entire contents of which are incorporated herein by reference.

### BACKGROUND OF THE INVENTION

The present invention relates to co-molding polymeric final parts, where the final parts are elongated and have minimally-angled sidewalls and are made from plastics co-molded to produce a quality final product with high quality visible surface, such as vehicle roof racks.

Co-molding and multi-shot injection molding processes are known for molding a product from two different plastics. One such co-molding process includes steps of molding a first component of a first polymeric material between first and second die halves, leaving the molded first component in the ejector-side first die half (a “common core”) while pulling away the second die half, mating a third die half against the first die half, molding a second (different) polymeric material onto first component to form a final part, leaving the final part in the first die half (i.e. in the “common core”) while pulling away the third die half, and then removing the final part from the first die half (by “ejecting” the final part). (See FIGS. 2-4 illustrating a prior art final part and prior art molding dies for making same.)

In particular, a known prior art co-molding process uses a “common core” die half 100 (FIGS. 3-4) mated with an ejector-side “first shot cavity” die half 101 to mold a prior art roof rack component 102 (see FIG. 3) of a first harder polymeric material, and then uses the “common core” die half 100 with a “second shot cavity” die half 103 to mold lips 104′ of soft material onto the component 102 to form the roof rack final part 104 (see FIG. 4). Notably, the “common core” die half 100 forms the non-show surface 105 of the roof rack final part 104, and is designed to permit removing the final part 104 from the “common core” die half 100 (by ejection rods) after the die halves 100 and 103 are opened at an end of the co-molding process.

FIGS. 2-4 illustrate that the prior art roof rack component 102 and co-molded final part 104 have widely angled sidewalls 106, angled such as about 40-45 degrees from the die pull direction 107 (i.e. the die opening direction, also called “die draw direction”). These widely angled sidewalls 106 are necessary to facilitate the illustrated molding process, including providing sufficient steel in the dies to allow formation of anti-skid ribs 108 in the non-show surface 105 without molding problems caused by shifting of the component 102 (i.e. movement of the partially-molded component) during the second molding step. The illustrated anti-skid ribs 108 are in the common core die half 100, which works because the first molded component 102 always stays with the ejector-side common core die half 100 until removal of the final part 104. The illustrated anti-skid ribs 108 are intended to positively and stably retain the first molded part on the common core die half 100 throughout the co-molding process. Notably, in the illustration of FIGS. 3-4, the wide angle of the widely-angled sidewalls 106 is sufficient to allow the second material to be co-molded onto edges of the first component 102 without the use of moving die components (such as a slide, pull, or cam) in the common core 100 and/or in the mating die halves 101 and 103.

### BRIEF SUMMARY OF THE INVENTION

An aspect of the present invention includes a co-molding process comprising steps of molding a hard plastic first component between an ejector-side “common cavity” die half and a “first shot core” die half; and then co-molding a soft plastic onto the first component to form a final part having an elongated C-shaped cross section using the “common cavity” die half and a “second shot core” die half, where the “second shot core” die half includes shallow formations along an elongated edge of the final part on a non-show concave surface of the part, the formations having a shallow depth extending in a direction non-parallel a die pull direction such that protruding locks form in the formations during the co-molding step preventing the first component from shifting during the co-molding second step.

In another aspect of the present invention, a co-molding process comprises steps of molding a first component between first and second die halves, the first component including a first edge section of first material; positioning a third die half against the first die half with the first component therebetween, the third die half having steel abutting the first edge section but having shallow recess formations against the first edge section; co-molding a second material onto the first edge section including providing sufficient injection pressure to cause semi-molten portions of the first material to flow into the shallow recess formations to form protruding locks on the first edge section from the first material, such that the first component does not move during the step of co-molding; and removing the final part from one of the second and third die halves.

An object of the present invention is to provide a method and apparatus including a die set and co-molding process where a first molded component remains with a first die half during a first molding step, yet affirmatively causes a final co-molded part to remain with a third die half during a second molding step. Further, an object is to do this without using any die slides or cams or pulls in the mold halves.

An object of the present invention is to provide pressure activated expansion locks that are formed during a second injection part of the co-molding process.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a perspective view of a roof rack component made using a hard and soft plastic that are co-molded using a co-molding process and molding die set according to the present invention.

FIG. 2 is a cross section of a prior art roof rack similar to that shown in FIG. 1; FIG. 2 illustrates a prior art C-shaped roof rack having two widely angled sidewalls.

FIGS. 3-4 are cross sections illustrating a prior art co-molding process where an ejector-side “common core” die half is first used with a first “shot cavity” die half to mold a first component with widely angled sidewalls and anti-skid ribs on a non-show surface (with the “common core” die half forming the non-show surface), and then where the “common core” die half is used with a second “shot cavity” die half to form a final part, the anti-skid ribs helping lock the first component and later lock the co-molded final part on the “common core” die half until the final part is ejected.

FIG. 5 is a cross section of a roof rack similar to that shown in FIG. 1 made by the present innovative process and apparatus, FIG. 5 illustrating a C-shaped roof rack having one minimally-angled sidewall that extends relatively close to being parallel a direction of die pull during a co-molding process and also having a non-angled sidewall that extends generally parallel the direction of die pull.

FIGS. 6-7 are cross sections illustrating a co-molding process of the present invention, where a “common cavity” die half is used with a “first shot core” die half to first mold a first component with non-angled sidewall and minimally-angled sidewall, the first component staying with the “common cavity” die half as the “first shot core” die half is pulled away, and then the “common cavity” die half is mated with a “second shot core” die half, the view being prior to co-molding soft plastic onto the first component to form a final part, the “second shot core” die half including shallow recesses for forming locks.

FIG. 8 is identical to FIG. 7, but shows injection of the second soft plastic, and FIG. 9 is an enlargement of the circled area in FIG. 8 in the location where the second soft plastic is molded, including lines showing movement of plastic around the locks.

FIG. 10 is a view of an inside surface showing the pressure activated expansion locks along an edge of the tip of the non-angled sidewall of the roof rack, the edge being on a non-show surface underside of the C-shaped cross section of the roof rack, the expansion locks forming a repeating pattern of X's that protrude slightly from the adjacent non-show surface, the expansion locks being formed by corresponding embossed marks extending into the “second shot core” die half along the corresponding edge in the tooling.

### PRIOR ART

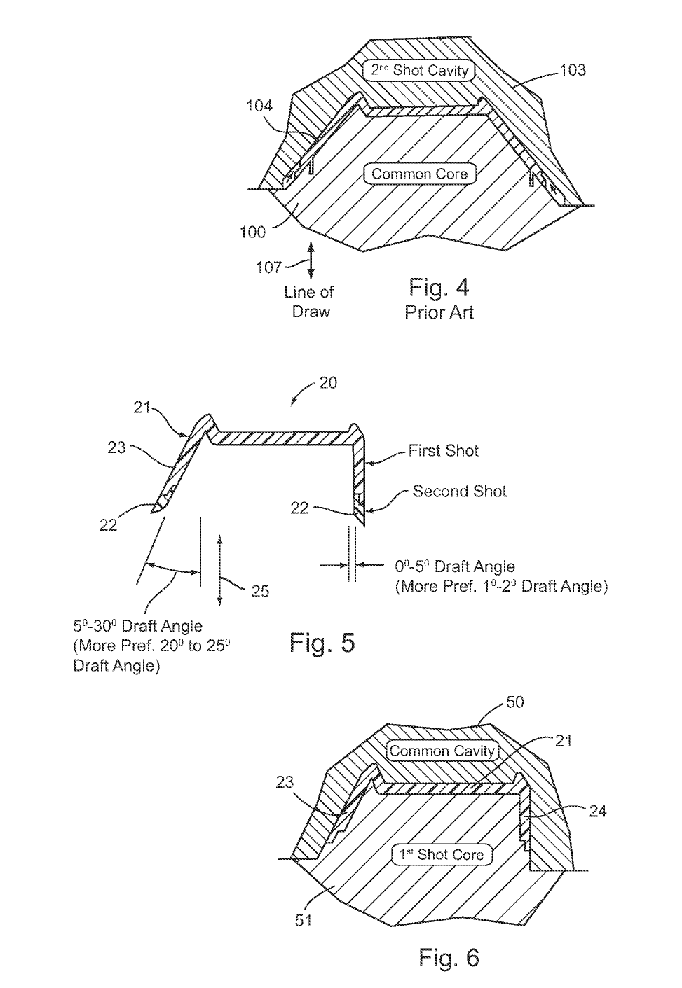

As discussed above, FIG. 2 shows a conventional design (roof rack final product 104) for 2-shot components, where a cross section of the co-molded C-shaped member has widely-angled sidewalls 106. With this design, the widely-angled sidewalls 106 that incorporate the second shot are on an angle of about 40-45 degrees angle from the line of draw (i.e. the “die pull direction 25”) in the tool. This part design facilitates a tool construction with a “common core”, as shown by FIGS. 3-4, as also discussed above.

The process sequence for the “conventional” 2-shot part 104 is shown in FIGS. 3 and 4. In FIG. 3, you can see the first shot cavity 101 and the common core 100 forming a C-shaped cavity where the first shot (i.e. roof rack component 102) is molded. After the first shot of the part is molded (i.e. component 102) and cooled sufficiently, then the component 102 remains on the common core 100 and the entire first shot plastic (component 102) and the common core 100 is transferred, or relocated, to mate with the second shot cavity 103. The second shot cavity 103 forms a cavity space designed to allow space for the second shot (soft) plastic to be injected into the second shot cavity to form flexible edges 104′ (also called lips 104′) on the component 102. As the second shot of soft plastic is injected into the mold (i.e. the cavity space created by mating die halves 100 and 103), there is enough plastic pressure applied to the first shot plastic (i.e. component 102) that causes the first shot plastic (component 102) to move during the injection of the second shot. The pressure direction is illustrated in FIG. 4 by the black arrows drawn on the part. Therefore, it is common practice to design “anti-skid ribs 108” that sufficiently secure the first shot plastic (component 102) into the common core 100. These anti-skid ribs 108 prevent the first shot plastic from moving during the second shot injection cycle. If the first shot plastic was not held in place and was allowed to move, there would be unacceptable defects on the final part 104 in the form of creases, inconsistent and incorrect dimensions, folds, scuffing, gloss variation, and other unacceptable defects.

### DETAILED DESCRIPTION OF PREFERRED EMBODIMENT

In roof racks having a “non-angled” sidewall that extends generally parallel a direction of die pull, or having “minimally-angled” sidewalls (i.e. sidewalls with a relatively steep draft angle), the co-molding process in prior art noted in the BACKGROUND OF THE INVENTION above, is not acceptable. For example, see FIGS. 5-7 which discloses a cross section of a roof rack 20 having a body 21 of hard plastic and co-molded flexible edge lips 22 of soft plastic, where the left and right side walls have a minimal or zero draft angle. Specifically, in the non-angled sidewall 24 of roof rack 20, there is no place to form an anti-skid rib 108 without it interfering with location of the second molded material forming the edge lip 22. In the minimally-angled sidewall 23, there is also insufficient steel in the molding die to form the anti-skid rib 108. Notably, even if there is enough steel in the molding die to physically form it, if an anti-skid rib 108 were formed in the minimally-angled sidewall 23 of FIG. 3, it would result in a very narrow pointed edge on the inboard side of the adjacent sidewall. The pointed edge would be relatively weak and easily damaged, which would lead to high maintenance due to the lack of robustness in the tool. Also, it would be especially difficult to adequately cool during the molding process, which would slow mold cycle times considerably (e.g. several tens of seconds or greater increase in mold cycle times). Without the anti-skid ribs, the second step of the co-molding process potentially causes the first molded component to move as the second plastic material is injected into the “common core” die half, resulting in creases, inconsistent and incorrect dimensions, folds, scuffing, gloss variation, and other unacceptable defects in the finally molded roof rack product. The above discussion is intended to clarify the present invention, and is not intended to suggest that roof rack final product 20 is (or is not) in prior art.

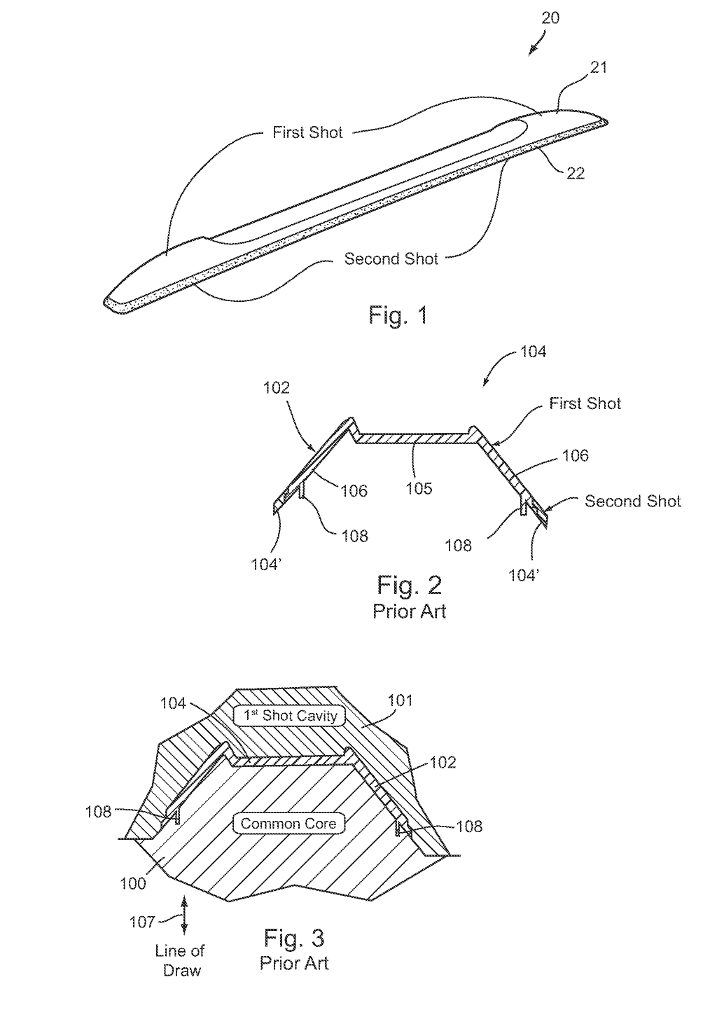

The roof rack 20 (FIG. 1) incorporating the present invention includes a body 21 and flexible edge lips 22 molded onto its edges. The illustrated roof rack 20 is elongated, such as greater than 10×longer than its width, and has a C-shaped cross section with minimally-angled first sidewall 23 (FIG. 5) that extends at about 15-30 degree draft angle (or more preferably about 20-25 degree draft angle) from the die pull direction 25, and having a non-angled second sidewall 24 that extends at about 0-5 degrees draft angle (or more preferably at about 1-2 degree draft angle) from the die pull direction 25. A pressure activated expansion lock 28 (FIGS. 9-10) causes a protruding material formation on the roof rack part 20 that causes the roof rack part to remain with a selected die mold half during co-molding operations.

The present co-molding process was developed to mold a first component (made of a hard plastic such as polypropylene) between an ejector-side “common cavity” die half (sometimes referred to as “common cavity” herein) and a “first shot core” die half (sometimes referred to as “first shot core” herein). Notably, the first component may or may not be retained in the “common cavity” die half while a “first shot core” die half is pulled away. The process further includes co-molding a soft plastic (such as thermoplastic elastomer) onto the first component to form a final part using the “common cavity” die half and a “second shot core” die half (sometimes referred to as “second shot core” herein).

In the present innovation, the above is achieved using pressure activated expansion locks 28 (“protruding locks”) formed by using the injection pressure of the soft plastic to move semi-molten hard plastic into shallow recesses in the second shot core die half 52. This is done without using any die slides, cams, or pull devices in the molds. Further, this is done without including a distortion or feature in the final part that detracts from the overall aesthetic appearance of the molded final part. Notably, this present difficulty of preventing distortions in the final part is exacerbated in the illustrated roof rack since the molded final part has a C-shaped or concave cross section with a “non-angled” sidewall 24 that extends almost parallel a direction of die pull 25. The parallel nature of this sidewall 24 tends to cause all or portions of the final part to shift during the second step of the co-molding process, thus causing molding defects. Further, the difficulty is made even more difficult since the present roof rack molding is substantially elongated; having a length dimension that is over 10× longer than the part's width dimension.

Shown in FIG. 1 is an elongated plastic component (i.e. a co-molded roof rack final product 20) that is comprised of two different materials; one material being a hard plastic making up a body 21 (also called “component”) and one material being a soft plastic making up a flexible edge lip 22 (also called “component herein”) that are molded within the same injection molding tool. As described below, the tool is constructed in such a way that allows one of the materials (i.e. the hard plastic) to be injected first. The “first shot” is then moved to a different core (or a different cavity). The “new” core (or cavity) is designed to mold the second material (i.e. the soft plastic) onto edges of the first material. It is noted that the first shot part can be “moved” to the second core or cavity by several different possible methods used in multi-shot molding. These include, but are not limited to, a rotating platen, or other rotating table or platform device. It is contemplated that the part could also be moved by hand, by a robot, or by other forms of automation. The illustrated roof rack final product 20 has a minimally-angled sidewall 23 angled at about 15-30 degrees or more preferably about 20-25 degrees to the die pull direction 25, and a non-angled sidewall 24 angled at a minimal draft angle of about 0-5 degrees, or more preferably about 1-2 degrees from the die pull direction 25.

FIGS. 5-7 show that the illustrated 2-shot component 20 (i.e. the roof rack final product 20) has relatively steep sidewalls 23 and 24, especially the sidewall shown on a right side of the figure. Once again, these sidewalls incorporate the second shot and are on a much steeper angle when compared to the line of draw 25 in the tool. This part design would not allow for the prior art process described above, where a “common core” is used, since the sidewalls in component 20 are sufficiently steep so that it is not possible to “place” anti-skid rib on the sidewalls. Thus, a “common cavity” type co-molding process is a better alternative, which is possible given the present innovation.

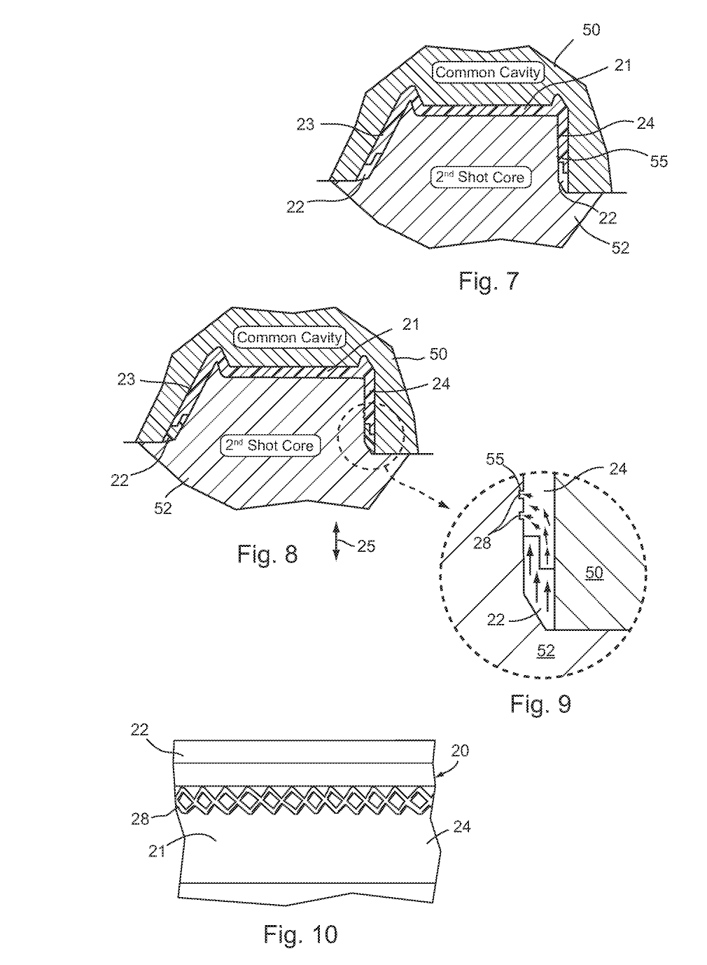

Specifically, the process sequence for the 2-shot part final product 20 has steeper sidewalls 23, 24 (as shown in FIG. 5), so that the tool construction requires a “common cavity” (mold die 50) and is shown in FIGS. 6 and 7. In FIG. 6, you can see the first shot core 51 and the common cavity 50. This is where the first shot (component 21) of the part is molded. After the first shot of the part is molded and cooled sufficiently, then the entire first shot plastic (component 21) and the common cavity 50 is transferred, or relocated, to the second shot core (mold die half 52). The second shot core 52 is designed to allow space along the edge of the body 21 for the second shot (soft) plastic to be injected into the second shot core 52. As the second shot is injected into the mold (mated die halves 50 and 52), there is enough plastic pressure applied to the first shot plastic such that it causes the first shot plastic (i.e. semi-molten material within side walls 23 and 24 near their edges) to move during the injection of the second shot. The pressure direction is illustrated in FIG. 8 and FIG. 9 by the black arrows drawn on the part. If the first shot plastic (i.e. component 21) is not held in place and instead is allowed to move, there would be unacceptable defects on the part in the form of creases, inconsistent and incorrect dimension, folds, scuffing, gloss variation, and other unacceptable defects.

A part of the problem is described as follows. Because the common cavity 50 (in FIGS. 6-8) has the “A-surface” (i.e. the highly visible surface that is visible to consumers) for the final product 20, it is not acceptable to mold “anti-skid ribs” into the first shot plastic component 21 on the common cavity 50. In addition, it's not possible to mold the anti-skid ribs in the first shot core 51, because of the angle of the side walls 23 and 24 and because any ribs molded in the first shot core (and given relief in the second shot core 52) would not be tight enough to prevent movement and hence would not prevent the aforementioned defects.

The present innovation focuses on a solution to the above problem, the solution being shown in FIGS. 8-10. Small details (a series of shallow recesses 55 that define a series of interconnected XXXXs, see FIG. 10) are cut into or embossed into the second shot core 52 near an edge of the sidewalls 23 and 24. For example, the recesses 56 can be 0.5 mm deep, and form a series of X-shapes that are about 5 mm tall (see FIG. 10). These small details (recesses 55) form in the sidewalls 23 and 24 pressure activated expansion locks 28 (also called “protruding locks” hereafter). When the mold (die halves 50 and 52) are closed with the first shot plastic (component 21) on the common cavity 50 and with the second shot core die half 52, there is now space for semi-molten parts of the first shot plastic 21 to flow into the pressure activated expansion locks 28. As the second shot soft plastic is injected to form lips 22, the pressure from the second shot soft plastic applies force onto the semi-molten portions of the first shot hard plastic (component 21). Because the first shot hard plastic is still near the glass transition temperature, the plastic is still semi-molten and is thus forced into the recesses 55 to thus form the pressure activated expansion locks 28. These locks 28 prevent the first shot plastic (component 21) from moving, thus preventing the aforementioned defects during the co-molding process. The locks 28 extend in a direction non-parallel the die pull direction 25. The locks 28 may also be made to cause the final product 20 to remain with the second shot core die half 52 when the common cavity 50 is pulled away, but the locks 28 are sufficiently shallow that the locks 28 permit the final product 20 to be removed from the second shot core 52 without causing defects in the final product 20.

It is to be understood that variations and modifications can be made on the aforementioned structure without departing from the concepts of the present invention, and further it is to be understood that such concepts are intended to be covered by the following claims unless these claims by their language expressly state otherwise.

The invention claimed is:

1. A co-molding process comprising steps of:
molding a hard plastic first component between a “common cavity” die half and a “first shot core” die half;
then co-molding a soft plastic onto the first component to form a final part having an elongated C-shaped cross section using the “common cavity” die half and a “second shot core” die half, where the “second shot core” die half includes shallow formations along an elongated edge of the final part on a non-show concave surface of the part, the formations having a shallow depth extending in a direction non-parallel a die pull direction such that protruding locks form in the formations during the co-molding step preventing the first component from shifting during the co-molding second step.

2. The process defined in claim 1, wherein the locks are sufficiently shallow to allow the “second shot core” die half to release the final part without surface defects and part distortions on the final part.

3. The co-molding process defined in claim 1, wherein the “common cavity” die half and the “second shot core” die half do not include a movable die slide or cam or pull.

4. The co-molding process defined in claim 2, wherein the “common cavity” die half and the “second shot core” die half combine to define a final-sized cavity for the final part that is at least 10 times a width of the C-shaped cross section.

5. A co-molding process comprising steps of:
molding a first component between first and second die halves, the first component including a first edge section of first material;
positioning a third die half against the first die half with the first component therebetween, the third die half having steel abutting the first edge section but having shallow recess formations against the first edge section;
co-molding a second material onto the first edge section including providing sufficient injection pressure to cause semi-molten portions of the first material to flow into the shallow recess formations to form protruding locks on the first edge section from the first material, such that the first component does not move during the step of co-molding; and
removing the final part from one of the second and third die halves.

6. The process defined in claim 5, wherein the locks are formed to cause the final part to stay on the third die half when the first and third die halves are separated.
